(19) United States
(12) Patent Application Publication
(10) Pub. No.: US 2013/0159351 A1
(43) Pub. Date: Jun. 20, 2013

(54) Asset Identity Resolution Via Automatic Model Mapping Between Systems With Spatial Data

(71) Applicants: Hendrik F. Hamann, Yorktown Heights, NY (US); Jeffrey Owen Kephart, Cortlandt Manor, NY (US); Jonathan Lenchner, North Salem, NY (US); Peini Liu, Beijing (CN); Bo Yang, Beijing (CN)

(72) Inventors: Hendrik F. Hamann, Yorktown Heights, NY (US); Jeffrey Owen Kephart, Cortlandt Manor, NY (US); Jonathan Lenchner, North Salem, NY (US); Peini Liu, Beijing (CN); Bo Yang, Beijing (CN)

(73) Assignee: International Business Machines Corporation, Armonk, NY (US)

(21) Appl. No.: 13/325,758

(22) Filed: Dec. 14, 2011

(51) Int. Cl. G06F 17/30

(52) U.S. Cl. 707/792; 707/E17.055

(57) ABSTRACT

Techniques for mapping between data models where objects represented in the data models include common physical objects or assets are provided. In one aspect, a method for mapping between data models, each of which describes a location of objects in a physical area includes the following steps. Common attributes are found in each of the data models. Location attributes are found among the common attributes in each of the data models, i.e., those attributes that describe the location of the objects in the physical area. The location attributes are used to identify a given one of the objects common to each of the data models, based on a placement of the given object by the data models at a same location (at a same time) in the physical area to establish a common identity of the object within the models. Attributes other than location attributes may then be mapped.

### FIELD OF THE INVENTION

The present invention relates to data models and more particularly, to techniques for mapping between data models.

### BACKGROUND OF THE INVENTION

When using data from two or more systems with different naming conventions for physical objects it is often a substantial and largely manual process to reconcile the identity of the objects to merge the data from the divergent systems. Known solutions include manual reconciliation or occasionally using a software mapping tool to turn naming conventions used in one system into an effective mapping from that system's object attribute naming to another system's object attribute naming. Even in the latter case, a fair amount of specialized coding or configuration of the mapping tool must be performed to effect the reconciliation. Moreover, naming conventions will differ so each mapping is specialized, yielding a solution which is not general.

For example, in current management systems for smart data centers or smart buildings, data are collected about assets and from a variety of sensors, which are associated with multiple management products, often provided by a variety of vendors. A data center, for example, may have the following deployed management systems: an asset management system for accounting and finance, an energy management for green IT, a building management system managing a building's subsystems, like HVAC, lighting and security, and an IT service management (ITSM) system for managing back-office IT and its connection with business processes.

These management systems each typically have their own data model. There is often a requirement to share data, to achieve some level of integration, across products. Data model mapping and translation is thus important. It is however generally quite cumbersome to recognize the same object across different data models since, a priori, the process seems to require one to understand each piece of data in each data model semantically.

Therefore, improved techniques for model mapping between multiple management systems would be desirable.

### SUMMARY OF THE INVENTION

The present invention provides techniques for mapping between data models where objects represented in the data models include common physical objects or assets. In one aspect of the invention, a method for mapping between data models, each of which describes a location of objects in a physical area is provided. The method includes the following steps. Common attributes are found in each of the data models. Location attributes are found among the common attributes in each of the data models, i.e., those attributes that describe the location of the objects in the physical area. The location attributes are used to identify a given one of the objects common to each of the data models, based on a placement of the given object by the data models at a same location (at a same time) in the physical area so as to establish a common identity of the object within the data models. Attributes other than location attributes may then be mapped.

A more complete understanding of the present invention, as well as further features and advantages of the present invention, will be obtained by reference to the following detailed description and drawings.

### BRIEF DESCRIPTION OF THE DRAWINGS

FIG. 1 is a diagram illustrating an exemplary methodology for mapping between data models according to an embodiment of the present invention;

FIG. 2 is a diagram illustrating an example of how movement of a monitored object can be simulated and how data can be filtered based on what data is unchanged by the movement according to an embodiment of the present invention;

FIG. 3 is a diagram illustrating how the fact that one physical location can be occupied by only one object at a time can be used to guide location feature mapping according to an embodiment of the present invention;

FIG. 4 is a diagram illustrating an exemplary methodology for learning non-location attributes across systems according to an embodiment of the present invention; and

FIG. 5 is a diagram illustrating an exemplary apparatus for performing one or more of the methodologies presented herein according to an embodiment of the present invention.

### DETAILED DESCRIPTION OF PREFERRED EMBODIMENTS

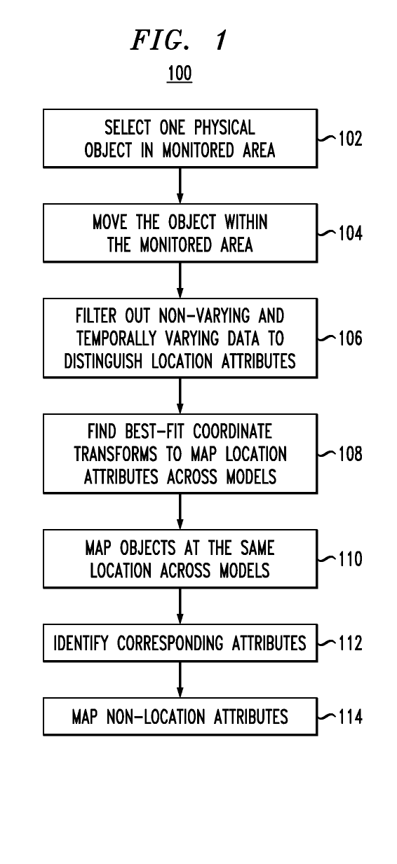

FIG. 1 is a diagram illustrating an exemplary methodology 100 for mapping assets between two data models. Two different software systems might describe the assets in a given physical area using different parameters (i.e., using different names, coordinates, etc.). The present techniques serve to map these assets across various different data models to allow even someone unfamiliar with the data models to easily identify a given asset and the attribute/attributes associated with that asset in each of the multiple data models. For example, the data models might be those used by a building information management system, an asset management system, and a data center energy management system. Data center IT and facilities assets might be tracked in all three systems, possibly with different coordinate systems (i.e., building-wide coordinates versus data center-wide coordinates). The term “asset” as used herein refers to physical objects in the physical area. Thus the terms “asset” and “object” are used interchangeably herein.

The data models relevant to the present techniques are those data models that describe assets/physical objects with spatial information (i.e., information which describes a location of the objects in the physical area). It is assumed here that at least two software systems are being deployed which cover the same (or partially overlapping) physical areas. If the areas are only partially overlapping the process is not vastly changed; however if the number of common objects is small, high levels of statistical confidence in asserting attribute or asset identity may not be possible. For the present methods to be statistically meaningful there must be ample data in the respective software systems so that statistical assertions can be made at, or around, the usual 95% confidence levels.

In step 102, at least one of the objects in the physical area is selected to be monitored. As will be described in detail below, monitoring the object(s) will involve moving the object(s). It is possible to monitor objects in groups, however, from a statistical point of view, it is far simpler to select and monitor one object at a time.

By way of example only, the physical area might be a data center and the object in the data center that is monitored might be a blade server. The choice of which object to monitor should be governed by how easy it is to move the given object to different locations in the physical area, as per step 104 (see below). Thus, using the example of a blade server, the server is readily movable, e.g., to other racks, or blade centers within the same rack in the data center. A second criterion for choosing an object to be monitored is that the object should not contain other objects, since one would in effect be moving a group of objects and the resultant statistical analysis would become considerably more complicated. Thus, in the data center example, it would be a poor choice to move an entire rack of equipment.

If it is known that the selected object exists in each of the data models, then selecting a single object is sufficient. However, if it is unknown whether the object exists in each of the data models, then several objects may be selected to ensure that at least one of the objects selected exists in each of the data models (i.e., so as to identify at least one common object across the disparate systems). A subsequent binary winnowing process may be performed to winnow the selection down to a single identifiable object that is movable and tracked in each of the systems. The process of performing such a binary winnowing, or binary search, is well known in the art. As highlighted above, it is also possible to perform the present techniques with multiple monitored objects.

In step 104, the selected object (from step 102) being monitored is moved, e.g., the object is moved from one location to another and then back, such that the object ends up in its initial location. In the simplest case, the object is moved manually (by a human user). For example, a data center operator can go into the data center and move a blade server from one rack to another or to another position on the same rack.

Different systems have different lag times between when an object is moved and when the object shows up as having been moved in the associated application. One must wait after moving the object for a sufficiently long time so that one is confident that the move has been registered in the respective systems (see below). If the systems are equipped with graphical user interfaces (GUIs) it may be possible to actually see the movement of the objects in the associated GUIs. Many applications have GUIs. For example, Revit® and Maximo Asset Management are applications with GUIs. If, however, there is no GUI in one or both systems, the lag time may be documented in the product literature. Thus, one would want to wait at least as long as the specified lag time to ensure that the movement has been registered in the data models. As a last resort, one may have to resort to trial and error, in other words, trying lag times of different lengths and proceeding through the ensuing steps of the present techniques to see what lag time is sufficient so that the movement is captured in both systems. By way of example only, for a given lag time, step 104 is performed by moving the object from one location to another (e.g., from location A to location B), waiting the required amount of time, moving the object back to the initial location (e.g., location A) and then wait the required amount of time, in order to ensure that the movement is registered by the system.

In some systems, especially those with GUIs, it may be possible to simulate the movement of objects—for example some systems for space and asset management, allow the system user to create “what-if” scenarios where assets are not physically moved but the user gets to see (e.g., via the GUI) what would happen if a given movement of an object (e.g., a piece of equipment such as a server) were to take place. If it is possible to simulate the movement of objects (based on the capabilities of the given system), step 104 can be performed with the simulated movement of an object in both systems, rather than any actual physical movement.

In step 106, attributes unchanged by the movement (or simulated movement) of the monitored object are removed from consideration as attributes pertaining to the location of the object so that the attributes that remain are those associated with spatial information, i.e., the location of the object in the area, or attributes that have varied in time during the course of the object move. Examples of time-variant attributes may be the CPU utilization or power consumption of a computer system. These time-varying but not location-based attributes are easy to identify and filter (again in step 106) because the attributes change not only during the object move, but even when the object is not moved. The attribute that changes only when the object is moved, and moreover changes from some set of initial values {Xᵢ=xᵢ}; i=i . . . N to some later set of values {Xᵢ=yᵢ}; i=i . . . N, when the object is moved, only to return to the initial values {Xᵢ=xⱼ}; i= . . . N, when the object is returned to its initial location are then deemed to be spatial information, and is what remains in consideration. It is assumed here that direct data queries of the two systems can be made to tell what attributes have changed. If motion is not detected in both systems it is concluded that the item chosen is not being tracked or is not present in both systems and steps 102-104 are repeated with another object.

What now remains in consideration after step 106 is just the location attributes in each of the systems—it remains to identify how to map from one set of location attributes to another. An attribute is a property of an object as captured in two distinct data models. Example attributes might be x,y,z coordinates (these would be location attributes), weight and color. In step 108, a best fit coordinate transformation is used to find the location attributes among the common attributes in each of the models. The best fit coordinate transformation is a set of parameters capturing the origin, rotation and scaling of the location coordinates in one data model relative to the coordinates in a second data model. In three dimensions, this means that three coordinates capture the translation from the first coordinate system to the second coordinate system (where the translation is expressed in the coordinates of the first coordinate system), three angles (typically the so-called Euler angles) give the rotation of the second coordinate system relative to the first, and three coordinates give the scaling of the second set of coordinate axes relative to the first set. The first two angles give the orientation of the x-axis in the second coordinate system relative to the first. A single angle is then needed to specify the orientation of the y-axis in the second coordinate system and the z-axis is determined by the so-called “right hand rule,” as is known in the art.

Thus in three dimensions, 9 parameters are needed in total to capture the transformation. In two dimensions, in other words, if, for example, just the x- and y-coordinates of objects are being tracked in the various systems, then 6 parameters would suffice. One can then move the object many additional times to get sufficient data to perform linear regression to recover a best fit transformation consisting of these 9 parameters (or 6 parameters if location is just to be captured in two dimensions).

A simple way to see that the problem of determining best fit parameters can be reduced to a linear regression problem is to note that the problem could also be thought of as one of finding the best fit affine transformation between the two coordinate systems, i.e., of finding transformations of the form:

yᵢ=Axᵢ+b i=1, . . . , N,

wherein A is a non-singular matrix (equivalently, linear transformation) and b is a translation vector. The values {xᵢ}, i=1, . . . , N give the coordinates of the object being moved to locations i=1, N in one coordinate system and the values {yᵢ}, i=1, . . . , N give the coordinates on the object moved in the second coordinate system. Note that each of the xᵢ and yᵢ are (either two-dimensional or three-dimensional) vectors. In two dimensions, fitting data (xᵢ, yᵢ) by finding the best fit values of m and b in the equations yᵢ=m xᵢ+b is the canonical linear regression equation in two variables. Above, essentially the same problem is present but in 12 variables in the three-dimensional case and in 6 variables in the two-dimensional case. Some degenerate variables are introduced in the three-dimensional case when the translation is made from (Euler angles, scaling and origin translation) to generic affine transformations because in the former case a right handed rectangular coordinate system is assumed.

The subject of linear regression is well know to those skilled in the art, and thus is not described further herein. If the identity of some number of assets known to both systems is known in advance, the positions of these common assets can be used as data input to the regression problem in lieu of, or in addition to, additional asset moves.

In step 110 we next map or identify objects at the same location across data models. This mapping may be performed by virtue of the fact that we know how to map location attributes in each of the models. Objects at the same location in each of the data models are assumed to be the same. Using the example of a data center, say the object is a server (Server A). Since the data models are characterizing the same physical area (or at least with regards to their overlapping regions) then Server A should appear in each of the data models and in the same location (i.e., regardless of where Server A was moved in step 104 since following the protocol, the assets should be moved back at the end of the step (see above)). The governing principle here is that two objects cannot occupy the same place at the same time, i.e., that two objects occupying the same location at the same time must be the same object. Thus, the location attributes at the same location in each of the models must necessarily then be associated with the (same) object which is at that location.

The next step 112 is to identify what attributes are shared by the two (or more) systems in addition to their location attributes. As one looks across the elements which are known to both of the two (or more) systems one will see some attributes that have identical values across the two systems and some which are extremely highly correlated. These attributes can be deemed to be shared attributes. An attribute in one system is highly correlated with an attribute in another system if the correlation coefficient (also known as the Pearson product-moment correlation coefficient) is close to 1. For example, if both systems have a height attribute, but in one system the height is stored in centimeters and in the other in inches, as you looked across elements, you would see that the values are not the same, but are extremely highly (perhaps even perfectly) correlated. In step 114, these non-location attributes that are highly correlated are then mapped, or deemed to be measuring the same quantities across systems.

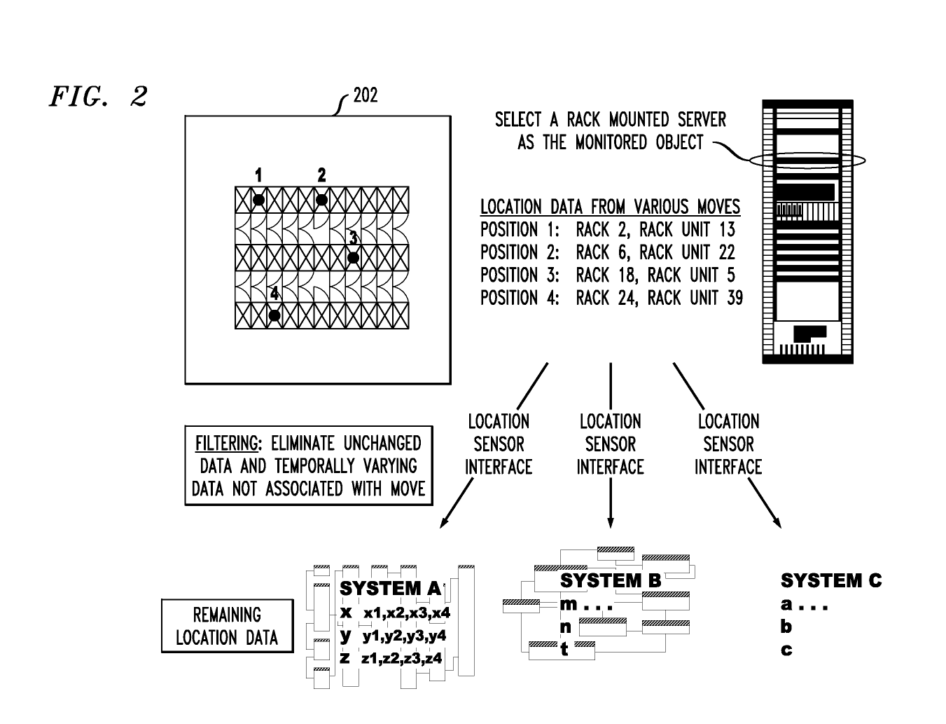

As described in conjunction with the description of steps 102-106 above, it is beneficial to select an object to be monitored in the area (step 102), move the object (step 104) and filter out non-location related data, i.e., the attributes that are unchanged when the object is moved or attributes which have purely temporal variation (step 106). This process is further illustrated by reference to the non-limiting example shown in FIG. 2. In the example shown in FIG. 2, the object being monitored is a rack mounted server. A floor plan plot 202 of an exemplary data center shows that the server is, in this example, moved to four different locations/positions in four different equipment racks in the data center. The first position is in equipment rack #2, rack unit 13. A “rack unit” is a vertical unit of measure used when positioning equipment within equipment racks. A rack unit equals 1.75″. Typical racks are 6′4″ tall. Rack unit 1 denotes the very bottom of the rack. The second position is in equipment rack #6, rack unit 22. The third position is in equipment rack #18, rack unit 5. The fourth position is in equipment rack #24, rack unit 39. The choice of location for these test moves is guided by a desire to give some variation in x-, y- and z-coordinates so that the filtering of step 106 can be performed adequately.

The term “Location Sensor Interface” refers to the systems that sense that the objects have been moved and populate the new location information into the respective databases. The location sensing can be performed by automated sensing devices or manually by human beings. The process by which this data gets populated is assumed to be unknown to the person responsible for mapping the data between models.

The attributes that are unchanged when the positioning of the server changes are eliminated (filtered) from consideration as location data. Additionally, attributes which are analyzed and deemed to be temporally varying data, not related to the location move are similarly filtered from consideration. The result is the spatial information, labeled “Remaining Location Data.” For example, as shown in FIG. 2, the remaining data from software system A is location information x, y and z, the remaining data from software system B is location information m, n and t and the remaining data from software system C is location information a, b and c.

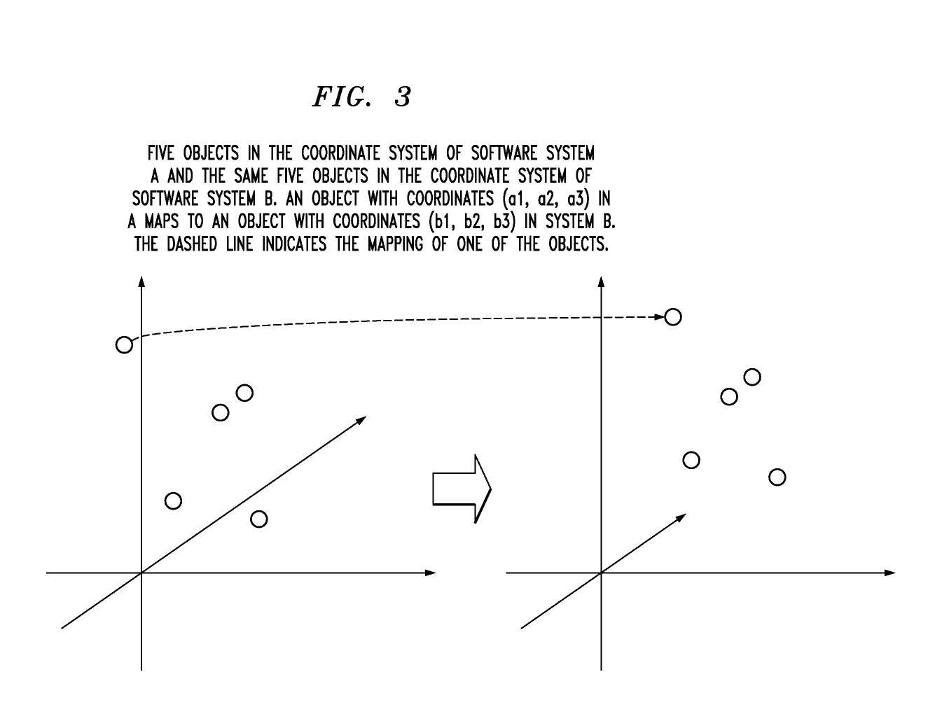

FIG. 3 is a diagram illustrating how the fact that one physical location can be occupied by only one object at a time can be used to guide location feature mapping even when the two representations of the same location are measured with different origins, different units of measurement and different orientation of axes. Using the example shown in FIG. 3, suppose 5 physical objects are being tracked. Software systems A and B capture the locations of the 5 objects independently. Software systems A and B have different coordinate systems; in this case the same axis orientations but different origins and units of measure, so system A has coordinates (a1,a2,a3) while system B has coordinates (b1,b2,b3), but (b1,b2,b3) are related to (a1,a2,a3) by a simple 9-parameter coordinate system transformation. In fact, since the axes are identically oriented, the transformation between system B and system A can be captured by just 6 parameters in this case.

As described above, once asset identity is known across systems, it is possible to use standard supervised or semi-supervised machine learning techniques to learn when the systems have additional attributes in common (beyond what was possible using simple correlation methods when object identity across systems was not known). In other words, a human user of the system can tell the system, or assist the system to a greater or lesser extent in determining when two attributes across systems are the same (for example, the system can propose that it thinks that two attributes are the same and the human user can either accept this proposal or reject it, in the latter case possibly providing the correct corresponding attribute. This capability is advantageous and can be used additionally to suggest possible errors in the data (when otherwise highly correlated data suddenly fail to be correlated), to learn (possibly with expert human assistance) a mapping between modeling languages (for example, one of the systems can submit a list of suspected associated attributes, together with its confidence (and perhaps a suggestion of the number of data outliers) to a human expert, who validates the mapping). The term “system” as used herein refers to the entire software system—the system incorporates or utilizes a data model.

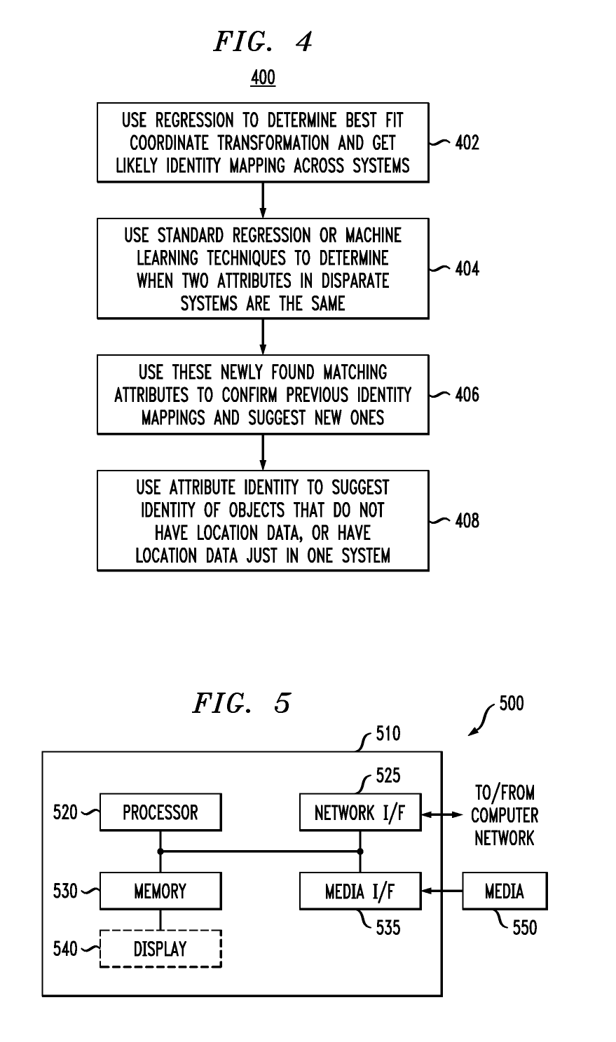

FIG. 4 is a diagram illustrating an exemplary methodology 400 for learning non-location attributes across models. In step 402, regression is used to determine best fit coordinate transformation and get likely identity mapping across systems. Given that we can identify common assets across systems, in step 404 standard regression or machine learning techniques are used to determine (or assist humans in determining) when two attributes in disparate systems are the same (i.e., are matching attributes), together with cross-system mapping of classification terms (e.g., an English system may use color=red while a French system may use color=rouge). In step 406, these newly found matching attributes (i.e., newly matching attribute values or newly matching assets) are used to confirm previous identity mappings and suggest new ones. By way of example only, an object in one system has a “twin” in another system if all of its attribute values in the one system correspond to all attribute values in the second system (that is for all attributes which are jointly monitored/measured in the two systems). New matches may indicate that asset location information is out of date, as often happens in such systems. Location information may go out of date since many times asset location information is maintained manually and in such cases, because of human error or laziness, location information is not kept updated.

In step 408, attribute identity is used to suggest identity of objects that do not have location information. While step 408 is not required, the present process is more powerful with this step. It is notable that not all objects will have location attributes—for example, software applications, configurations of networks and subnets, and so on. In step 408, the idea is to use location data to identify physical objects (objects with location information), use these objects to learn the identity of different named attributes across systems and models, and then use this correspondence to identify common non-location-based objects across systems and models.

Turning now to FIG. 5, a block diagram is shown of an apparatus 500 for implementing one or more of the methodologies presented herein. By way of example only, apparatus 500 can be configured to implement one or more of the steps of methodology 100 of FIG. 1 for mapping between data models, each of which describes a location of physical objects in a physical area.

Apparatus 500 comprises a computer system 510 and removable media 550. Computer system 510 comprises a processor device 520, a network interface 525, a memory 530, a media interface 535 and an optional display 540. Network interface 525 allows computer system 510 to connect to a network, while media interface 535 allows computer system 510 to interact with media, such as a hard drive or removable media 550.

As is known in the art, the methods and apparatus discussed herein may be distributed as an article of manufacture that itself comprises a machine-readable medium containing one or more programs which when executed implement embodiments of the present invention. For instance, when apparatus 500 is configured to implement one or more of the steps of methodology 100 the machine-readable medium may contain a program configured to find common attributes in each of the data models; find location attributes among the common attributes in each of the data models; and use the location attributes to identify a given one of the objects common to each of the data models based on a placement of the given object by the data models at a same location in the physical area so as to establish a common identity of the objects within the data models.

The machine-readable medium may be a recordable medium (e.g., floppy disks, hard drive, optical disks such as removable media 550, or memory cards) or may be a transmission medium (e.g., a network comprising fiber-optics, the world-wide web, cables, or a wireless channel using time-division multiple access, code-division multiple access, or other radio-frequency channel). Any medium known or developed that can store information suitable for use with a computer system may be used.

Processor device 520 can be configured to implement the methods, steps, and functions disclosed herein. The memory 530 could be distributed or local and the processor device 520 could be distributed or singular. The memory 530 could be implemented as an electrical, magnetic or optical memory, or any combination of these or other types of storage devices. Moreover, the term “memory” should be construed broadly enough to encompass any information able to be read from, or written to, an address in the addressable space accessed by processor device 520. With this definition, information on a network, accessible through network interface 525, is still within memory 530 because the processor device 520 can retrieve the information from the network. It should be noted that each distributed processor that makes up processor device 520 generally contains its own addressable memory space. It should also be noted that some or all of computer system 510 can be incorporated into an application-specific or general-use integrated circuit.

Optional video display 540 is any type of video display suitable for interacting with a human user of apparatus 500. Generally, video display 540 is a computer monitor or other similar video display.

Although illustrative embodiments of the present invention have been described herein, it is to be understood that the invention is not limited to those precise embodiments, and that various other changes and modifications may be made by one skilled in the art without departing from the scope of the invention.

What is claimed is:

1. A method for mapping between data models, each of which describes a location of objects in a physical area, the method comprising the steps of:
finding common attributes in each of the data models;
finding location attributes among the common attributes in each of the data models; and
using the location attributes to identify a given one of the objects common to each of the data models based on a placement of the given object by the data models at a same location in the physical area so as to establish a common identity of the objects within the data models.

2. The method of claim 1, wherein the location attributes describe the location of the objects in the physical area.

3. The method of claim 1, further comprising the step of:
mapping attributes other than location attributes.

4. The method of claim 1, wherein the location attributes are used to identify the given one of the objects common to each of the data models based on the placement of the given object by the data models at the same location, at a same time.

5. The method of claim 1, wherein the location attributes among the common attributes are found for each of the data models using a best fit coordinate transformation.

6. The method of claim 1, further comprising the step of:
selecting at least one of the objects in the physical area to provide at least one selected object;
moving the at least one selected object in the physical area; and
removing data that is unchanged by the movement of the at least one selected object from consideration as location data.

7. The method of claim 6, wherein the step of moving the at least one selected object comprises the step of:
selecting a plurality of locations in the physical area for movement of the at least one selected object to provide a plurality of selected locations.

8. The method of claim 7, further comprising the step of:
collecting data, from each of the data models, once a move to each of the selected locations is complete.

9. The method of claim 1, further comprising the step of:
selecting at least one of the objects in the physical area to provide at least one selected object;
simulating movement of the at least one selected object in the physical area; and
removing data that is unchanged by the simulated movement of the at least one selected object from consideration as location data.

10. The method of claim 9, wherein the step of simulating movement of the at least one selected object comprises the step of:
selecting a plurality of locations in the physical area for movement of the at least one selected object to provide a plurality of selected locations.

11. The method of claim 10, further comprising the step of:
collecting data, from each of the data models, once the simulated movement to each of the selected locations is complete.

12. An apparatus for mapping between data models, each of which describes a location of objects in a physical area, the apparatus comprising:
a memory; and
at least one processor device, coupled to the memory, operative to:
find common attributes in each of the data models;
find location attributes among the common attributes in each of the data models; and
use the location attributes to identify a given one of the objects common to each of the data models based on a placement of the given object by the data models at a same location in the physical area so as to establish a common identity of the objects within the data models.

13. The apparatus of claim 12, wherein the location attributes describe the location of the objects in the physical area.

14. The apparatus of claim 12, wherein the at least one processor is further operative to:
map attributes other than location attributes.

15. The apparatus of claim 12, wherein the at least one processor is further operative to:
select at least one of the objects in the physical area to provide at least one selected object;
move the selected object in the physical area; and
remove data that is unchanged by the movement of the selected object from consideration as location data.

16. The apparatus of claim 15, wherein the at least one processor when moving the selected object is further operative to:
select a plurality of locations in the physical area for movement of the selected object to provide a plurality of selected locations.

17. The apparatus of claim 13, wherein the at least one processor is further operative to:
collect data, from each of the data models, once a move to each of the selected locations is complete.

18. An article of manufacture for mapping between data models, each of which describes a location of objects in a physical area, comprising a machine-readable recordable medium containing one or more programs which when executed implement the steps of:
finding common attributes in each of the data models;
finding location attributes among the common attributes in each of the data models; and
using the location attributes to identify a given one of the objects common to each of the data models based on a placement of the given object by the data models at a same location in the physical area so as to establish a common identity of the objects within the data models.

19. The article of manufacture of claim 18, wherein the location attributes describe the location of the objects in the physical area.

20. The article of manufacture of claim 18, wherein the at least one processor is further operative to:
map attributes other than location attributes.

21. The apparatus of claim 18, wherein the one or more programs which when executed further implement the steps of:
selecting at least one of the objects in the physical area to provide at least one selected object;
moving the selected object in the physical area; and
removing data that is unchanged by the movement of the selected object from consideration as location data.

22. The article of manufacture of claim 21, wherein the one or more programs which when executed to perform the moving step further implement the step of:
selecting a plurality of locations in the physical area for movement of the selected object to provide a plurality of selected locations.

23. The article of manufacture of claim 22, wherein the one or more programs which when executed further implement the step of:
collecting data, from each of the data models, once a move to each of the selected locations is complete.
